(19) United States
(12) Patent Application Publication
(10) Pub. No.: US 2019/0128756 A1
(43) Pub. Date: May 2, 2019

(54) SENSOR ROLLER

(71) Applicant: BWG Bergwerk- und Walzwerk-Maschinenbau GmbH, Duisburg (DE)

(72) Inventors: Andreas NOE, Kerken (DE); Christoph MOOS, Isselburg (DE)

(21) Appl. No.: 16/170,336

(22) Filed: Oct. 25, 2018

(30) Foreign Application Priority Data
Oct. 27, 2017 (DE) 102017125294.0

(51) Int. Cl. G01L 5/04; G01B 5/28

(52) U.S. Cl. CPC G01L 5/045; G01L 1/16; G01B 5/28

(57) ABSTRACT

A sensor roller for determining planarity errors and/or for determining the tension of a strip tangentially engaging the roller has a roller body rotatable about an axis, having an outer surface, and formed with a plurality of radially outwardly open recesses axially spaced on the surface. Rigid sensor bodies each in a respective one of the recess each have an outer surface generally flush with the outer surface of the roller body. Each sensor body forms with a side surface of the respective recess a peripheral circumferentially fully extending gap. Respective force-measuring sensors in the recesses are each braced between a respective one of the sensor bodies and the roller body radially inward of the respective sensor body. An annular weld seam of welding compound is formed in each of the gaps

### FIELD OF THE INVENTION

The invention relates to a sensor roller for determining (and/or monitoring) planarity errors of a normally metallic strip and/or for determining (and/or monitoring) the tension of the strip.

### BACKGROUND OF THE INVENTION

In such a sensor roller one or more sensors are integrated into a roller body, and the sensors each have at least one sensor body that is flush with the respective body, is mounted on one or more respective force-measuring sensors, and forms a peripheral gap in a respective recess in the roller body.

Such a sensor roller, which is also referred to as a planarity-sensor roller, is used particularly to identify planarity errors in strips, particularly metal strips, determined by a measurement of the tension distribution over the width of the strip, with the strip that is under longitudinal tension over the entire width of the strip, wrapping around the planarity-sensor roller at a predetermined wrap angle and thereby exerting local contact pressure forces on the planarity-sensor roller corresponding to the local longitudinal tension distribution crosswise to the strip, from which local contact pressure forces the tension distribution can be determined. It is possible to immediately detect strip defects and, in particular, ripples or strip cambers, since deviations in the length of individual strips are represented by differences in tension.

The bodies of the individual sensors form covers that act on the force-measuring sensors, for example piezoelectric quartz crystals, arranged underneath. It is advantageous that the covers be braced against the roller body with interposition of the piezoelectric quartz crystals. In order to minimize force transmission between the sensors or covers and the roller body on the other hand, the sensor body and covers are decoupled by a peripheral gap of the roller body and braced exclusively against the force sensors. The sensors and covers are thus moved over the course of the load without significant deformation of the cover against the force-measuring sensors.

The planarity-sensor roller known from U.S. Pat. No. 5,629,487 has sensors embodied as cover disks that rest on respective force transducers. A plurality of such sensors are distributed over the width of the strip, so that the tension for different transverse positions is detected with the individual sensors.

The planarity-sensor roller known from U.S. Pat. No. 7,357,022 has planarity-measuring bars integrated into the roller surface as sensors that are supported on force detectors and extend over the width of the strip oblique to the roller axis in order to determine the tension distribution, so that such a measuring bar extends both axially and angularly of the roller. With such a measuring bar extending obliquely to the roller axis, a multiplicity of measured values can be recorded successively that are respectively assigned to different axial positions along the roller and thus also transversely of the strip, so that measurements can be performed at different axial positions using a sensor body (namely a measuring bar).

In contrast, U.S. Pat. No. 9,784,574 describes a planarity-sensor roller with a plurality of sensors integrated into the roller surface that are distributed at different axial positions for the purpose of measuring the tension over the width of the roller. The sensors extend with their longitudinal directions running in the strip travel direction when seen in a plan view of the roller surface perpendicular to the roller axis, so that a plurality of measured values can be determined with the sensors for each revolution of the roller for the respective axial position.

U.S. Pat. No. 8,132,475 describes a sensor roller where a measuring bar is provided that extends as a tension-measuring bar for determining the time course of the tension substantially angularly over a predetermined surface region. This sensor roller can thus be used to determine the tension of a strip and, in particular, to monitor the tension of a strip over a period of time. It is possible to provide such a tension-measuring bar as a reference bar on the one hand and to provide sensors, planarity-measuring bars, for example, for measuring planarity on the other hand, thus enabling a planarity measurement and a tension measurement to be performed, respectively. The reference measuring bar thus records variations in the tension over time. Since these fluctuations of the tension over time are superimposed on the planarity-measuring signal of the planarity sensors, the influence of the tensile stress fluctuations in the strip over time can thus be filtered out of the measurement signal of the planarity-measuring bars.

All of sensor rollers of the described types are based on the idea of decoupling the sensors (for example covers/metering bars or the like) from the roller body in order to avoid a force bypass, particularly at the described peripheral gap between the sensor body and the roller body. The penetration of dirt particles into the gap can pose a constant problem. Furthermore, the fundamental risk exists of the peripheral gap producing undesirable marks on the strip, provided that it does in fact extend continuously as far as the roller surface and consequently directly up to the strip (for example metal strip).

According to U.S. Pat. No. 5,629,487, the penetration of dirt into the movement gap is prevented by sealing this gap with an O-ring or a plastic layer. The problem of roll marks on the strip is not dealt with.

Alternatively or in addition, planarity-sensor rollers with coatings of plastic, such as for example PU coatings, are used in practice. Such a solution is particularly advantageous when processing aluminum or stainless-steel strips.

In the case of steel strips, however, it is preferred to dispense with such a plastic coating so that, alternatively, a hard coating of wear-resistant metals is applied to the planarity-sensor roller. In practice, the problem exists that the hard coating tends to crack at the movement gaps under such a hard coating due to micromovements of the covers of the force-measuring sensors. Therefore, DE 298 24 236 proposes that a shell such as a hard coating be applied to a support tube, i.e. that the planarity-sensor roller be encased by a support tube and that the hard coating be applied thereto in the form of a shell by for example thermal spraying. It is true that this avoids the above-described problems involving the formation of cracks in the hard coating. Force transmission via the support tube causes interference, however, so that the measurement signals are adversely affected.

On that basis, U.S. Pat. No. 7,143,657 has alternatively proposed that the sensors be covered with one or more metal foils that are adhesively bonded to the roller surface, so that, in turn, a shell can be applied to the sensor regions that are covered by the metal foils or to the entire roller surface, which can be made of a hard metal, such as hard chrome or tungsten carbide, for example, or of rubber or plastic, such as for example polyurethane.

Moreover, a sensor roller is known from EP 1 759 778 that has a support body and sensors made of piezoelectric material integrated therein for measuring radial force components of the tension acting on the outer shell of the support body and/or the temperature of the strip material and/or support body. The tubular support body has a shell, and the sensors are between the support body and the shell, with the piezoelectric material of the sensors being bonded to fibers that extend longitudinally of the sensors and parallel to the surface of the support body of the sensor roller. The shell can have a wear-inhibiting outer layer.

### OBJECTS OF THE INVENTION

It is therefore an object of the present invention to provide an improved planarity- and/or tension-measuring sensor roller.

Another object is the provision of such an improved sensor roller that overcomes the above-given disadvantages, in particular that ensures detection of planarity-measurement errors and/or of the tension of a strip, particularly of a metal strip.

In particular, damage or roll marks on the metal strip are to be prevented while simultaneously avoiding or at least minimizing force transmission between the sensors and the roller body.

### SUMMARY OF THE INVENTION

A sensor roller for determining planarity errors and/or for determining the tension of a strip tangentially engaging the roller has according to the invention a roller body rotatable about an axis, having an outer surface, and formed with a plurality of radially outwardly open recesses axially spaced on the surface. Rigid sensor bodies each in a respective one of the recess each have an outer surface generally flush with the outer surface of the roller body. Each sensor body forms with a side surface of the respective recess a peripheral circumferentially fully extending gap. Respective force-measuring sensors in the recesses are each braced between a respective one of the sensor bodies and the roller body radially inward of the respective sensor body. An annular weld seam of welding compound is formed in each of the gaps generally at the outer surfaces of the roller body and respective sensor body.

Thus the object is attained by sealing or covering the peripheral gaps between the sensor body and the roller body with a welding compound at the outer surface of the roller body, i.e. on the roller surface at the radial outer end of the gap.

In a first embodiment of the invention, this can be achieved by forming a continuous weld seam made of the welding compound into the peripheral gap (from the outer surface of the roller body), with the weld seam extending only over a relatively small region relative to the radial depth of the gap, so that only a weld seam with a small thickness of for example 0.5 mm to 5 mm, 1 mm to 4 mm, or preferably 1 mm to 3 mm is provided. The peripheral gap is therefore closed with a (thin) weld seam around the entire periphery of the roller body and is thus sealed, but only over a small portion of the depth of the gap, so that the gap between the roller body and sensor body is substantially preserved but remains sealed only at the surface of the roller body. In the course of experiments, it was surprisingly found that the measured results are not or not substantially affected by such a “partial closure” of the gap, that is, force transmission between the sensor body and the roller body through the welding compound does not distort the measured result, or at least not substantially. All that happens is that a weaker signal is detected than without the welding compound, i.e. there is a signal reduction. However, the determination of the tensile stress or tension distribution is not critically impaired. By sealing the gap with the aid of the welding compound, it is possible to reliably prevent the strip from being influenced by roll marks that can occur near the sensors in the prior art, since a uniform, closed roller surface, and a metallic roller surface, at that, is realized. As such, the invention can be used particularly in such metal strips in which a plastic coating should be preferably dispensed with. Closing of the gap also has the advantage that, with an additional hard coating, crack formation in the hard coating is prevented even with continuous operation.

The described advantages are realized in equal measure in a second embodiment of the invention, namely in which the roller body is provided, at least in the region of the sensors, but preferably over the entire surface, with a coating of the welding compound that is made by deposition welding and covers the peripheral gap. In this embodiment, the welding compound according to the invention therefore does not introduce a singular weld into the peripheral gap, but rather the (entire) roller surface is provided with a weld coating of the welding compound by deposition welding. A closed (metallic) roller surface is also created in this way, meaning that roll marks and thus damage to the strip can be avoided without a noteworthy force bypass (negatively) impacting the measurement. Similarly to how the described weld seam is made, even though a reliable closure is created over the entire circumference of the gap, it is also only over a small depth here as well. After all, the thickness of the weld coating is preferably only for example 0.5 to 5 mm, 1 mm to 4 mm, or especially preferably 1 mm to 3 mm.

All in all, a closed, metallic roller surface is achieved by sealing or covering the peripheral gap with a layer of the welding compound (either through introduction of a singular weld seam or application of a weld cladding) that enables flawless measurement of the tension or tension distribution to be performed even with such strip materials in which it is best not to use a plastic coating. The sensor roller according to the invention can therefore be preferably used in the processing of steel strip.

In order to produce a uniform, smooth roller surface, it is advantageous to grind the roller body after application of the welding compound (weld seam and/or weld coating) and to thus produce a smooth, polished roller surface.

It is possible to use the sensor roller with this polished surface. In a preferred development, however, it is advantageous to additionally apply a hard coating to the roller body after application of the welding compound (for example the weld seam and/or the weld coating) and, if appropriate, after grinding, which hard coating finally forms the outer surface of the sensor roller during operation. Such a hard coating can be formed in an inherently known manner by for example thermal spraying. The hard coating can be made of a hard metal, such as for example hard chrome and/or tungsten carbide. The thickness of such a hard coating, which is applied for example by thermal spraying and must not be confused with the inventive weld coating in the context of the invention, is preferably 0.05 mm to 0.2 mm, that is, it is preferably (substantially) thinner than the weld coating or weld seam that is introduced into the gap. The problems observed in the prior art in connection with such a hard coating (in particular, crack formation as a result of micromovements) do not occur in the context of the invention, since the loads of the hard coating are lower due to the (previous) sealing or covering of the gap according to the invention.

In a preferred embodiment, the two above-described embodiments (weld seam on the one hand and weld coating on the other hand) can also be combined with each other. This means that the gap can first be sealed with the aid of the (thin) weld seam and then a weld coating can be applied by deposition welding. The hard coating can then be optionally applied in the described manner.

The advantage here is the fact that the covering or sealing of the peripheral gap is performed with a preferably identical material, i.e. a material that is similar to the material of the roller body, with the roller body being preferably made of steel. Consequently, steel is also preferably used as the welding compound.

In connection with the described embodiment with a weld seam, it is particularly advantageous if the edge of the sensor body turned toward the gap and/or the edge of the roller body turned toward the gap are beveled (prior to application of the welding compound) in order to form chamfers. Such a geometric adaptation of the gap near the roller surface by formation of one or two chamfers constitutes optimal preparation for the weld seam, for example in the sense of a V-seam, so that an optimal and particularly durable weld is formed even with a relatively low thickness.

The invention further relates to a method of making a sensor roller of the described type, with the sensor body being inserted into the recess with interposition of the force-measuring sensors to form the peripheral gap. According to the invention, this peripheral gap is then sealed or covered in the described manner with a welding compound. According to the first embodiment, this is achieved by introducing a (continuous) weld seam of the welding compound into the peripheral gap and/or by providing the surface of the roller body with a weld coating of the welding compound at least in the region of the sensors, preferably over the entire surface, by deposition welding, that covers the peripheral gap. In preparation for the weld seam, one or more chamfers can be provided in the described manner on the sensor body and/or on the roller body.

In terms of process engineering, it is advantageous if the surface of the roller body that is “modified” by introduction and/or application of the welding compound is subsequently polished. Optionally, the above-described hard coating can be applied by thermal spraying, for example, after application of the welding compound and, optionally, after polishing.

In particular, the sensor roller according to the invention can be a planarity-sensor roller and thus designed to determine and/or monitor the planarity of a strip, particularly of a metal strip. Both embodiments with singular sensors that are distributed over the width of the strip, for example cover disks (according to U.S. Pat. No. 5,629,487 and embodiments with measuring bars that extend obliquely to the roller axis, can be included for continuous measurement over the width of the strip (for example according to U.S. Pat. No. 7,143,657). Furthermore, the embodiments described in U.S. Pat. No. 9,784,574 can be realized in which a plurality of measuring bars are provided over the width of the strip that extend with their longitudinal direction in the strip travel direction when seen in a top view of the roller surface radially of the roller axis, so that a plurality of measured values can be detected with such a sensor per roller revolution for a respective axial position.

Alternatively or in addition, however, the sensor roller can also be embodied as a tension sensor roller for determining and/or monitoring the tension of a metal strip, so that, in particular, a reference bar according to U.S. Pat. No. 8,132,475 is provided that essentially acts as a tension-measuring bar for determining the time course of the tension along the peripheral direction over a predetermined peripheral region.

A welding compound for sealing or covering the peripheral gap is always employed in the different uses or embodiments according to the invention that are described.

The invention is especially preferably used in the processing of metal strips, for example steel strips. Alternatively, however, it also lies within the scope of the invention to use the sensor roller for the processing of sandwich strips, for example strips of a composite material composed of metal (steel, for example) and plastic.

### BRIEF DESCRIPTION OF THE DRAWING

The above and other objects, features, and advantages will become more readily apparent from the following description, reference being made to the accompanying drawing in which:

FIG. 1 is a simplified radial view of a sensor roller for determining and/or monitoring the planarity of a strip,

FIG. 2 is a section through the sensor roller according to line II-II of FIG. 1,

FIG. 3 is a section through the sensor roller according to line FIG. 2,

FIG. 4 is a section through the object according to line A-A of FIG. 1 of a second embodiment of the invention, and

FIG. 5 is a section through the sensor roller according to line V-V of FIG. 4.

### SPECIFIC DESCRIPTION OF THE INVENTION

As seen in the drawing, a sensor roller 1 that serves as a planarity-sensor roller for determining and/or monitoring planarity errors and/or the planarity of a strip, particularly of a metal strip is rotatable during operation about a normally horizontal axis R, although it is not normally driven. It can for example be part of a strip-treatment or strip-processing line where the strip passes horizontally above and perpendicular to the roller axis R. The unillustrated strip is under a predetermined tension over its entire width and therefore tensioned, and wraps around the planarity-sensor roller at a predetermined small wrap angle that can for example be 2° to 10°. The determination of the strip planarity and/or the identification of planarity errors is done indirectly using the sensor roller 1 by measuring the of tension at a plurality of locations spaced transversely across the width of the strip, that is perpendicular to the horizontal strip-travel direction and to a vertical plane including the roller rotation axis R.

For this purpose, the sensor roller 1 has a roller body 2 and a plurality of sensors 3 distributed over the cylindrical roller outer (or peripheral) surface axially and/or angularly and integrated into the roller body 2. Each of these sensors 3 has a sensor body 4 that is flush with the roller body 2 and fits in a respective radially outwardly open recess 5 in the roller body 2, so as to form a peripheral gap 6 between the sensor body 4 on the one hand and the roller body 2 on the other. The sensors 3 are set in the respective recesses 5 on one or more piezoelectric force-measuring sensors 7. In the illustrated embodiment, the sensor bodies 2 are pressed against the roller body 2 by for example mounting screws 8 to cover and press the sensors 7 radially inward against the floors of the respective recesses 5. Alternatively, however, bracing with tie rods in a manner known per se can also be considered, in which case two sensors diametrally opposite one another and exposed at the surface of the roller can be braced against one another using tie rods. The roller body 2 is also provided with through holes 14 under the sensor body 4, for example for passing connector cables through to the sensors 7. Such cables lead off to a monitoring computer.

The drawing shows embodiments in which the sensors 4 are elongated and extend with their longitudinal direction running in the strip travel direction and angularly of the roller surface when seen in a view of the roller surface radially perpendicular to the roller axis R, with it being possible for a plurality of measurements to be made by the sensors 3 for each revolution of the roller for the respective axial or transverse position on the roller body 2. In the illustrated embodiments, the individual sensors 3 are thus correlated with individual axial positions, so that a measurement is performed with each individual measuring bar 4 at a specific axial position of the metal strip, thereby realizing a solution according to U.S. Pat. No. 9,784,574.

According to the invention, the peripheral gap 6 is sealed or covered with a welding compound.

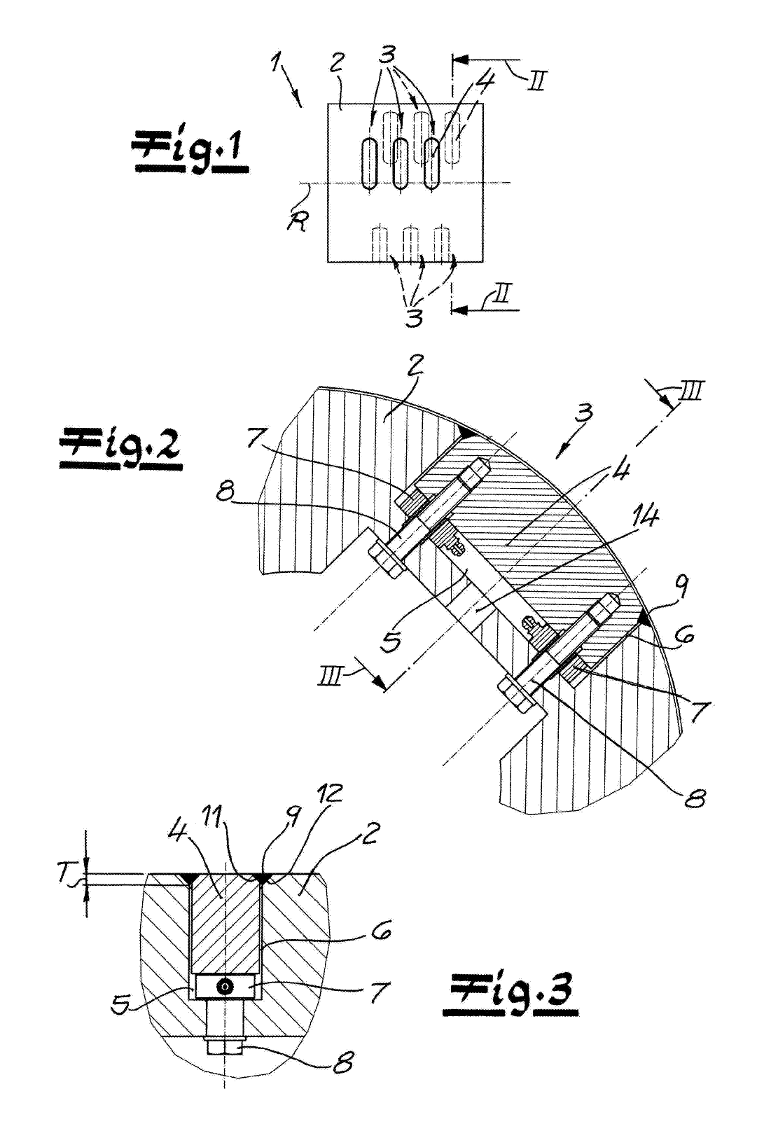

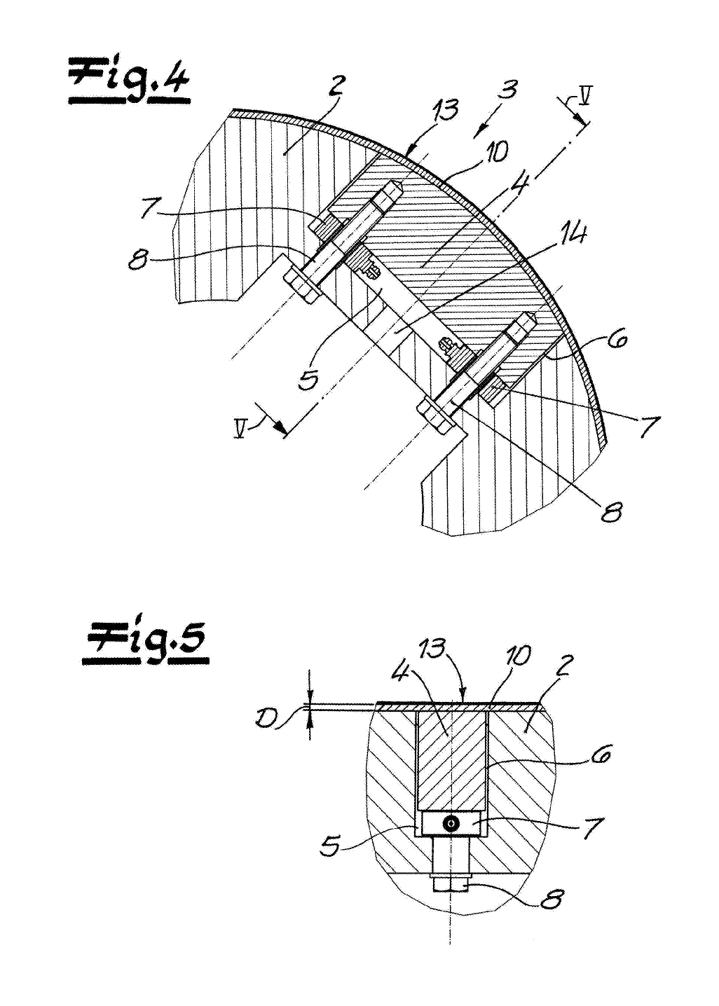

In this regard, FIGS. 2 and 3 show a first embodiment in which a peripheral weld seam 9 made of the welding compound is introduced into the radial outer edge of the peripheral gap 6. The edge of the sensor body 4 facing toward the gap 6 is beveled in order to form a first chamfer 11. Furthermore, in the illustrated embodiment, the edge of the roller body 2 facing toward the gap is beveled in order to form a second chamfer 12. These chamfers 11, 12 serve as preparation for the triangular-section weld seam 9 that seals the peripheral gap 6 near the surface of the roller body before the welding compound is applied. A completely closed roller surface is thus formed by this weld seam 9 that allows flawless measurements to be made without damaging the metal strip. In the illustrated embodiment, a radial depth T along the depth of the gap is for example from 1 mm to 3 mm.

After formation of the weld seam 9, it is advantageous to polish the roller surface during manufacture of the sensor roller shown in the drawing. It is then possible to optionally apply a completely closed shell to the surface of the roller body 2 (including the surface of the sensor body 4) in the form of a hard coating 13 that can for example be done by thermal spraying and has for example a thickness of only 0.05 mm to 0.2 mm.

FIGS. 4 and 5 show a second embodiment of the invention where the surface of the roller body 2 is provided at least in the region of the sensors 3, but preferably over the entire surface, with a weld coating 10 of the welding compound that is made by deposition welding and covers the peripheral gap 6. In this embodiment, the radial thickness D of this weld coating 10 can for example be 1 mm to 3 mm. In this embodiment as well, it is advantageous for the roller surface to be polished after application of the weld coating 10. Again, a hard coating 13 can then be optionally applied in the manner described above. In any case, in the embodiment according to FIGS. 4 and 5 as well, the peripheral gap is sealed by a very thin cover layer of the welding compound to form a closed roller surface without falsification of the measurement results due to force deflection.

The figures show an embodiment with sensors that extend perpendicular to the roller axis. However, the invention can be implemented in equal measure in other known embodiments, such as those with singular, round sensors or with measuring bars that extend for example oblique to the roller axis. Furthermore, the invention can also be implemented in connection with a tension-measuring bar such as that known for example from U.S. Pat. No. 8,132,475 where the sensor roller can also determine the tension of a strip.

We claim:

1. A sensor roller for determining planarity errors and/or for determining the tension of a strip tangentially engaging the roller, the roller comprising:
a roller body rotatable about an axis, having an outer surface, and formed with a plurality of radially outwardly open recesses axially spaced on the surface;
rigid sensor bodies each in a respective one of the recess, each having an outer surface generally flush with the outer surface of the roller body, and each forming with a side surface of the respective recess a peripheral circumferentially fully extending gap;
respective force-measuring sensors in the recesses each braced between a respective one of the sensor bodies and the roller body radially inward of the respective sensor body; and
an annular weld seam of welding compound in each of the gaps generally at the outer surfaces of the roller body and respective sensor body.

2. The sensor roller defined in claim 1, wherein the weld seam extends into the peripheral gap.

3. The sensor roller defined in claim 1, wherein the surface of the roller body at least in the region of the sensors is provided with a weld coating made by deposition welding and that covers the peripheral gaps.

4. The sensor roller defined in claim 3, wherein the hard coating overlies the weld seam and the outer surfaces of the roller and sensor bodies.

5. The sensor roller defined in claim 3, wherein the weld coating has a thickness of from 0.5 mm to 5 mm.

6. The sensor roller defined in claim 1, wherein an edge of the sensor body facing toward the respective gap at the outer surface of the roller body is beveled to form a chamfer.

7. The sensor roller defined in claim 1, wherein an edge of the roller body facing the gap at the outer surface of the roller body is beveled to form a chamfer.

8. The sensor roller defined in claim 1, wherein the weld seam in the gap has a depth of from 0.5 mm to 5 mm.

9. The sensor roller defined in claim 1, wherein the welding compound is of the same material as the roller body and/or the sensor body.

10. The sensor roller defined in claim 9, wherein the weld seam, roller body, and sensor bodies are of steel.

11. A method of making a sensor roller comprising the steps of:
inserting into each of a plurality of radially outwardly open and axially spaced recesses of a roller body rotatable about an axis and having a substantially cylindrical outer surface a respective sensor body with an outer surface of each sensor body generally flush with the roller outer surface and each sensor body being peripherally and fully circumferentially spaced by a peripheral gap from an inner surface of the respective recess;
providing radially between each sensor body and a floor surface of the respective recess a piezoelectric force-measuring sensor; and
forming at the surfaces in the gap between the sensor bodies and the roller body a weld seam of welding compound closing the gap and angularly and axially supporting the sensor bodies in the respective recess while permitting limited radial movement of the sensor bodies in the respective recesses.

12. The method defined in claim 11, wherein the weld seam is introduced into the peripheral gap and/or the outer surface of the roller body is provided with a weld coating of the welding compound by deposition welding that covers the peripheral gap.

13. The method defined in claim 11, further comprising the step of:
beveling an edge of the sensor body facing toward the gap to form a chamfer before formation of the weld seam, or
beveling an edge of the roller body facing toward the gap to form a chamfer before formation of the weld seam.

14. The method defined in claim 13, wherein both edges are beveled and the weld seam is made of triangular cross section.

15. The method defined in claim 11, further comprising the step of:
forming a hard coating over the welding compound.

16. The method defined in claim 15 wherein the hard coating is formed by thermal spraying.

17. The method defined in claim 15, wherein the hard coating is applied to the entire outer surface of the roller body as well as the outer surfaces of the sensor bodies.
